(19) United States
(12) Patent Application Publication
(10) Pub. No.: US 2009/0195096 A1
(43) Pub. Date: Aug. 6, 2009

(54) FLYWHEEL POWER SUPPLY DEVICE

(75) Inventor: Shoji Suzuki, Shizuoka (JP)

Correspondence Address: BROWDY AND NEIMARK, P.L.L.C.;624 NINTH STREET, NW, SUITE 300, WASHINGTON, DC, 20001-5303, US

(73) Assignee: Suzuki Press Kogyosho, Co. Ltd, Shizuoka (JP)

(21) Appl. No.: 11/908,936

(22) PCT Filed: Mar. 15, 2006
(86) PCT No.: PCT/JP2006/305175

§ 371 Date: Feb. 9, 2009

(30) Foreign Application Priority Data
Mar. 16, 2005 (JP) 2005-076061

(51) Int. Cl. H02K 7/02; H02K 7/08

(52) U.S. Cl. 310/74; 310/90

(57) ABSTRACT

The present invention provides a flywheel power supply device which can maintain a favorable lubrication state in a bearing portion of a flywheel thus exhibiting excellent maintainability and, at the same time, effectively preventing troubles such as an energy loss attributed to a load resistance applied to the bearing portion and noises generated by a precession of the flywheel. A flywheel power supply device 10 is characterized in that the power supply device includes a flywheel 11 which is rotatably driven upon receiving supply of electricity, converts holding kinetic energy into electric energy when the supply of electricity is stopped, and releases the electric energy; a lower bearing portion 13 which is fixed to a body casing 12 for supporting a rotary shaft 11b which is mounted on a lower side of the flywheel 11 in a projecting manner; an upper bearing portion 14 which is fixed to the body casing 12, the upper bearing portion 14 rotatably supporting an upper portion of the flywheel by fitting a fixed shaft 14a which extends downwardly therefrom into a bearing hole 11c formed in an upper surface of the flywheel 11; and a lubricating oil storing portion 15 which is formed around the bearing hole 11c formed in the flywheel 11.

### TECHNICAL FIELD

The present invention relates to a back-up power supply device which stores and holds rotational kinetic energy by rotating a flywheel, converts the rotational kinetic energy into electric energy when the supply of electricity is stopped, and can supply stable electricity to a device.

### BACKGROUND ART

A flywheel power supply device is a back-up power supply device which stores energy as rotational kinetic energy by rotating a flywheel with the use of electric energy, converts the rotational kinetic energy into the electric energy again when the supply of electricity is stopped due to an electrical power failure or the like, and can supply stable electricity to a device.

With respect to such a conventional flywheel power supply device, for example, patent document 1 discloses a power supply device which supports a rotary shaft of the flywheel on a bearing mounted on a casing, and rotates the flywheel at a high speed in a so-called spin-top state in which only a lower end of the rotary shaft of the flywheel is supported as a fulcrum of rotation and an upper end of the rotary shaft forms a non-contacting portion.

Further, patent document 2 discloses a flywheel power supply device which rotates a flywheel in a state that upper and lower portions of a rotary shaft of the flywheel are supported, and a fulcrum of rotation positioned at a lower end of the rotary shaft of the flywheel and the center of gravity of the flywheel are arranged on a resultant-force acting line of a magnetic attraction force which acts on the flywheel. In such a flywheel power supply device, permanent magnets are arranged on an inner circumferential surface of a circular recessed portion formed inside the rotating flywheel, and a stator which is formed by combining cores and coils which are arranged to face the permanent magnets is arranged on a bottom portion of the casing. Due to such a constitution, when a voltage is applied to the coils of the stator, the flywheel is rotated based on the same principle as an electric motor and kinetic energy is stored in the flywheel. When the supply of electricity to the coils is stopped due to an electric power failure or the like, the kinetic energy of the flywheel is converted into the electric energy based on the same principle as an electric generator and the electric energy is supplied to the outside.

[Patent document 1] Japanese Patent No. 3188591
[Patent document 2] JP-A-10-285835

### DISCLOSURE OF THE INVENTION

Problems that the Invention is to Solve

The flywheel power supply device does not use harmful substances such as lead compared to a battery-type back-up power supply device and hence, the flywheel power supply device is easily recycled. Accordingly, as a back-up power supply device which replaces the battery-type back-up power supply device, the flywheel power supply device is expected to become a mainstream of a measure to cope with an instantaneous interruption of the power supply.

However, a conventional flywheel power supply device disclosed in patent document 1 is configured such that the flywheel which constitutes a rotational body is rotated in a so-called spin-top state in which only a lower end portion of the flywheel forms a fulcrum of rotation and an upper end of the flywheel forms a non-contacting portion. Accordingly, the upper end of a rotary shaft of the flywheel generates a precession in which the upper end tilts drawing an arc about the fulcrum of rotation at a lower end of the rotary shaft of the flywheel thus giving rise to a drawback that a flywheel rotation is not stabilized. Further, the upper end of the flywheel forms the non-contacting portion and hence, a serious drawback that the flywheel may jump out from a casing due to large vibrations such as an earthquake has been pointed out.

Further, the flywheel power supply devices disclosed in patent document 1 and patent document 2 do not adopt the structure which allows a bearing portion of the flywheel to maintain a favorable lubrication state and hence, there exists a possibility that a malfunction occurs when electricity is supplied thus giving rise to a drawback that a maintenance of the bearing portion of the flywheel is indispensable.

Particularly, with respect to the flywheel power supply device disclosed in patent document 2, a touchdown bearing which is mounted on an upper portion of the rotary shaft of the flywheel adopts the so-called outer-rotating-type structure in which a ball bearing is mounted on a short shaft which is integrally fixed on a casing and the ball bearing is loosely fitted into a circular recessed portion of the flywheel thus giving rise to a drawback that the stability of the flywheel is not ensured with respect to vertical vibrations.

The present invention has been made to overcome the above-mentioned drawbacks, and it is an object of the present invention to provide a flywheel power supply device which allows a bearing portion of a flywheel to maintain a favorable lubrication state thus exhibiting excellent maintainability and, at the same time, effectively preventing troubles such as an energy loss attributed to a load resistance applied to the bearing portion and noises generated along with a precession of the flywheel.

Further, it is another object of the present invention to provide a flywheel power supply device which can stably rotate a flywheel having a weight of 100 kg or more at a high speed.

It is still another object of the present invention to provide a flywheel power supply device which is used as a back-up power supply device which can firmly support a flywheel in the inside of a casing even when strong vibrations such as an earthquake are generated.

### Means for Solving the Problem

A flywheel power supply device of the present invention is characterized in that the power supply device includes a flywheel which is rotatably driven upon receiving supply of electricity, converts holding kinetic energy into electric energy when the supply of electricity is stopped, and releases the electric energy; a lower bearing portion which is fixed to a body casing for supporting a rotary shaft which is mounted on a lower side of the flywheel in a projecting manner; an upper bearing portion which is fixed to the body casing, the upper bearing portion rotatably supporting an upper portion of the flywheel by fitting a fixed shaft which extends downwardly therefrom into a bearing hole formed in an upper surface of the flywheel; and a lubricating oil storing portion which is formed around the bearing hole formed in the flywheel.

A flywheel power supply device according to claim 2 is, in the flywheel power supply device having the constitution described in claim 1, characterized in that an oil circulating passage which takes in lubricating oil stored in the lubricating oil storing portion through a peripheral-wall intake port formed in an upper-portion-side peripheral wall of the fixed shaft and discharges the lubricating oil from a lower-end discharge port of the fixed shaft is formed in the fixed shaft of the upper bearing portion.

A flywheel power supply device according to claim 3 is, in the flywheel power supply device having the constitution described in claim 1 or 2, characterized in that a lubricating-oil-flow restricting portion formed in a projecting manner in a ring-shape or an umbrella-shape is mounted on a side wall surface of the fixed shaft of the upper bearing portion.

### BEST MODE FOR CARRYING OUT THE INVENTION

In the present invention, a flywheel includes a rotary shaft which extends downwardly therefrom and a bearing hole formed in an upper portion thereof in a recessed shape and is rotatably arranged in the inside of a body casing.

In the inside of the flywheel formed in a cylindrical shape, a permanent magnet member for generating an induced electromotive force and a weight member made of heavy metal for holding a predetermined moment of inertia are provided.

Further, at the center of a bottom portion of the body casing, a plurality of stators formed of cores and coils is radially arranged in a state that the plurality of stators face the rotating permanent magnet which is arranged in the inside of the flywheel in an opposed manner. In this constitution, an induced electromotive force can be generated in the coils along with the rotation of the permanent magnet, while a rotational force can be applied to the flywheel which incorporates the permanent magnet therein by applying an electric current to the coils.

As a lower bearing portion, a fixed recessed portion is formed in the center of the bottom portion of the body casing, and as a material of the lower bearing portion, abrasion-resistant metal, ceramics or the like can be named.

Here, in a portion of lower bearing which is brought into contact with the rotary shaft of the flywheel, an oil reservoir portion may be formed to always store lubricating oil like a pool when necessary.

As a fixed shaft of an upper bearing portion, a portion of the body casing which extends downwardly from a center portion of an inner side of the body casing and has a distal end thereof formed in a pivot shape or a spherical shape is formed. As a material of the fixed shaft, besides stainless steel, steel or the like, for example, carbide or nitride of Ti, V, Cr, Zr, Nb, Mo or W, cemented carbide which is made of a combination of metals such as Fe, Ni and Co, and ceramics such as alumina, silicon carbide or silicon nitride or the like can be named.

A lubricating oil storing portion is configured such that, around a bearing hole formed in an upper rotation center portion of the flywheel, a recessed portion in which the fixed shaft of the upper bearing portion is inserted is formed, and an upper portion of an opening of the recessed portion is covered with a disc-like lid portion. Due to such structure, it is possible to prevent the lubricating oil which is stored in the inside of the lubricating oil storing portion from being scattered around due to a centrifugal force.

Further, as an oil circulation passage, a flow passage for the lubricating oil is formed in the columnar fixed shaft in a penetrating manner. The lubricating oil taken into the flow passage through a plurality of intake ports formed in a peripheral wall of the fixed shaft flows in the axial direction of the fixed shaft through horizontal passages, and flows downwardly through a vertical passage formed along the axis of the fixed shaft, and is discharged from a lower-end discharge port formed in the fixed shaft.

As a lubricating-oil-flow restricting portion, a ring-shaped or umbrella-shaped projecting portion is formed on a side-wall surface of the fixed shaft, and as a material of the lubricating-oil-flow restricting portion, plastic, metal or the like can be named.

The lubricating-oil-flow restricting portion is provided for restricting the flow of the lubricating oil around the fixed shaft which is held around the rotating bearing hole.

### EMBODIMENT 1

Hereinafter, a flywheel power supply device according to the embodiment 1 of the present invention is more specifically explained in detail in conjunction with drawings.

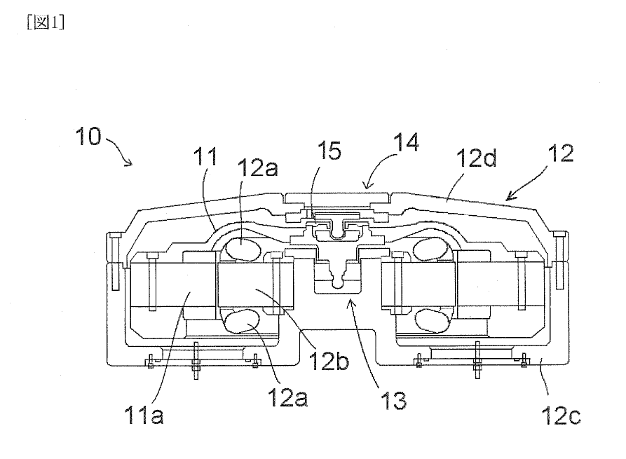

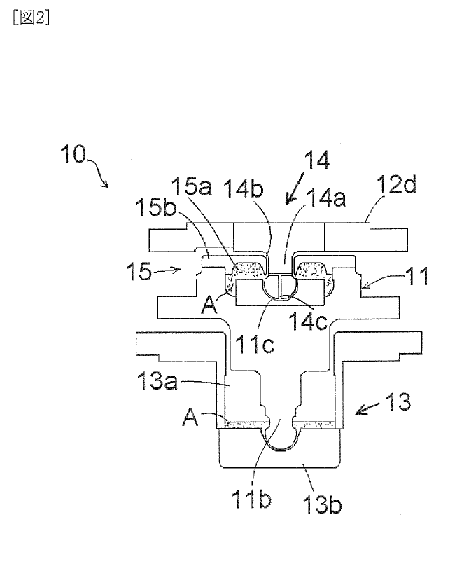

FIG. 1 is a cross-sectional view of the flywheel power supply device of the embodiment 1, and FIG. 2 is a partially enlarged view of the flywheel bearing structure.

As shown in FIG. 1 and FIG. 2, the flywheel power supply device 10 of the embodiment 1 rotatably holds the flywheel 11 in the inside of a body casing 12 in a state that an upper portion and a lower portion of a rotary shaft of the flywheel 11 are supported on the body casing 12.

The flywheel 11 is arranged to be rotatably driven on a horizontal plane with the supply of electricity via a permanent magnet 11a.

Further, the body casing 12 can be divided or split in the vertical direction, and holds a stator formed of coils 12a and cores 12b around a center portion in the inside thereof.

Further, at the center of a bottom portion in the inside of the body casing 12, a lower bearing portion 13 is arranged. The lower bearing portion 13 supports a distal end of the rotary shaft lib which is formed on a lower side of the flywheel 11 in a projecting manner.

Further, at an upper portion in the inside of the body casing 12, an upper bearing portion 14 is arranged. The upper bearing portion 14 rotatably supports an upper portion of the flywheel 11 in a state that a fixed shaft 14a which projects downwardly is fitted into a bearing hole 11c formed in an upper surface of the flywheel 11.

Further, a lubricating oil storing portion 15 is formed around the bearing hole 11c formed in the flywheel 11.

The flywheel power supply device 10 is used as an uninterruptible power system (UPS), for example, as an emergency power source of a device such as medical instrument, a computer or the like. The flywheel power supply device 10 stores supplied electric energy as kinetic energy of a rotational body (flywheel) and, at the time of an electric power failure, releases the kinetic energy stored in the rotational body, and converts the kinetic energy into electric energy, and supplies electricity to a device such as medical instrument or a computer thus maintaining a stable operation of the device.

Here, the flywheel power supply device 10 may be also used in combination with a capacitor-type power supply device or a battery-type power supply device so as to further enhance the assuredness of operation at the time of a disaster such as an earthquake.

A contour of the body casing 12 may preferably be formed in a disc-like shape having an outer diameter of approximately 600 mm and a height of approximately 200 mm, for example, and the body casing 12 may adopt the two-split structure which is formed by connecting a lower casing 12c and an upper casing 12d using bolts or the like. The lower bearing portion 13 is arranged on a bottom portion of the lower casing 12c, and the stator formed of the coils 12a and the cores 12b is arranged around the lower bearing portion 13. The upper bearing portion 14 having a fixed shaft 14a which is inserted into the bearing hole 11c of the flywheel is fixed to the center of the inside of the upper casing 12d.

A contour of the flywheel 11 is formed in an approximately cylindrical shape as a whole, for example. The permanent magnets 11a are held on a circumferentially inner side of the flywheel 11 and, at the same time, a lower portion and an upper portion of the rotary shaft are supported in a firmly held manner at upper and lower positions in a state that the flywheel can be rotated on a horizontal plane by way of the lower bearing portion 13 and the upper bearing portion 14 respectively.

On a center bottom portion of the lower casing 12c, the stator is arranged. Here, the stator is configured such that the coils 12a which generate an induced electromotive force by rotating the permanent magnets 11a of the flywheel 11 are wrapped around the cores 12b.

In the flywheel power supply device 10, electricity is supplied to the coils 12a of the stator from an external power source so as to generate a rotational force in the flywheel 11 between the coils 12a and the permanent magnets 11a. For example, by rotating the flywheel 11 at a rotational speed of 1000 to 10000 rpm, the supplied electric energy is converted into and is stored as rotational kinetic energy of the flywheel 11.

Further, when the supply of electricity to a computer system or the like is stopped due to an electrical power failure or the like, the kinetic energy of the flywheel 11 is converted into the electric energy again and the electric energy is supplied to the computer system or the like.

Further, when the supply of electricity is started again and electricity is supplied to the coils 12a from the external power source again, the flywheel again returns to a rotational state in which the flywheel stores the electric energy as the kinetic energy.

Here, in the flywheel power supply device 10, the upper and lower portions of the flywheel rotary shaft are supported on the respective bearing portions in a firmly held manner. Accordingly, even when the flywheel is vibrated or the flywheel rotary shaft is inclined, it is possible to firmly hold the flywheel 11 by the upper and lower bearing portions. Further, the upper bearing portion 14 is configured such that the lubricating oil storing portion 15 is formed in the upper bearing portion 14 and hence, the friction resistance or the vibrations of the upper bearing portion 14 can be minimized.

The lower bearing portion 13 supports the rotary shaft 11b of the flywheel 11 by way of a distal end of the rotary shaft which is formed in a spherical shape or a pivot shape and constitutes a fulcrum of rotation of the flywheel 11.

Further, the lower bearing portion 13 forms a hollow portion 13a for storing lubricating oil A in a portion thereof which is in contact with the rotating flywheel.

Here, by forming helical grooves in the distal end of the rotary shaft 11b of the flywheel 11 and/or in a contact-receiving member 13b of the lower bearing portion 13 which is brought into contact with the rotary shaft 11b, the lubrication oil is introduced into a gap defined between the distal end of the rotary shaft 11b and the contact-bearing portion 13b thus effectively forming a lubricating-oil film layer whereby the rotary shaft 11b can be rotated in a floating manner.

As shown in FIG. 2 which is an enlarged view, the upper bearing portion 14 is arranged at the center of the inside of the upper casing 12d. Here, the upper bearing portion 14 includes a fixed shaft 14a which has a distal end thereof formed in an approximately spherical shape, and the lubricating oil storing portion 15 is arranged around the distal end of the fixed shaft 14a.

The lubricating oil storing portion 15 includes an oil pool portion 15a which is arranged around the bearing hole 11c of the flywheel 11 into which the fixed shaft 14a is inserted and is formed in an upper surface of the flywheel 11 in a recessed manner and a lid portion 15b which covers an opening portion of the oil pool portion 15a. A predetermined quantity of lubricating oil is held in the lubricating oil storing portion 15.

Here, in the distal-end spherical portion of the fixed shaft 14a, the helical grooves similar to the helical grooves formed in the distal end of the rotary shaft 11b of the flywheel 11 are formed.

Further, as shown in the drawing, an approximately T-shaped oil circulation passage may be formed in the fixes shaft 14a. The oil circulation passage is provided for taking in lubrication oil A stored in the oil pool portion 15a of the lubrication oil storing portion 15 through peripheral-wall intake ports 14b formed in an upper peripheral wall of the fixed shaft 14a, for discharging the lubrication oil A from a lower-end discharge port 14c, and for supplying the lubrication oil A into a gap defined between the fixed shaft 14a and the bearing hole 11c. Due to such a constitution, the T-shaped oil circulation passage can supply the lubrication oil to the distal end portion of the fixed shaft 14a and can maintain the lubrication around the fixed shaft 14a in a favorable state.

As the lubricating oil held in the lubricating storing portion 15, for example, known lubricants such as hydrocarbon-group based oil which is represented by mineral oil, ester-group mineral oil which uses ester which is a polar compound and oil which adopts polyolefin as base oil having low volatility and excellent heat resistance can be used.

The flywheel power supply device 10 according to the embodiment 1 is configured as described above and hence, the rotary shaft of the flywheel is supported in the vertical direction in a firmly held manner and can be stably rotated at a high speed.

Further, the lubrication of the upper bearing portion 14 of the flywheel 11 can be always held in a favorable state and hence, troubles such as an energy loss attributed to a load resistance of the bearing portion of the flywheel 11 and noises generated by a precession of the flywheel 11 can also be effectively prevented whereby it is possible to provide the flywheel power supply device which exhibits excellent reliability of operation.

Further, the flywheel power supply device of the present invention does not have the ball-bearing structure and hence, the replacement of bearing or the like is not necessary whereby the flywheel power supply device exhibits the excellent maintainability and, at the same time, exhibits excellent stability and reliability at the time of the occurrence of a seismic hazard or the like.

### EMBODIMENT 2

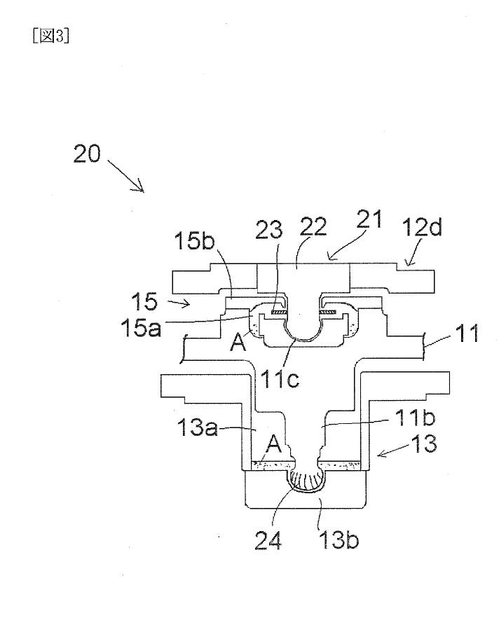

FIG. 3 is a partially enlarged view showing the flywheel bearing structure in a flywheel power supply device of the embodiment 2.

In FIG. 3, numeral 20 indicates the flywheel power supply device of the embodiment 2. The flywheel power supply device includes an upper bearing portion 21, a fixed shaft 22 of the upper bearing portion 21 which is formed in a state that the fixed shaft 22 is fitted into a bearing hole 11c formed in an upper surface of the flywheel 11, a ring-shaped or umbrella-shaped lubricating-oil-flow restricting portion 23 which is formed in a projecting manner on a side-wall surface of the fixed shaft 22 of the upper bearing portion 21, and helical grooves 24 which are formed in a distal end of a rotary shaft 11b of the flywheel 11 for facilitating the flow of the lubricating oil.

Here, in the flywheel power supply device 20 of the embodiment 2, parts having functions substantially equal to the parts of the flywheel power supply device 10 of the embodiment 1 are given same numerals and their explanation is omitted.

As a material for forming the lubricating-oil-flow restricting portion 23, rubber, plastic or the like can be named. In structure, the lubricating-oil-flow restricting portion 23 is configured such that a ring-shaped member having an outer diameter of 30 mm, an inner diameter of 14 mm and a thickness of 1 mm is fixedly mounted on an upper portion of the fixed shaft 22 of the upper bearing portion 21.

Due to the provision of the lubricating-oil-flow restricting portion 23, the movement of the lubricating oil A in which the lubricating oil A which is stored in the bearing hole 11c of the flywheel 11 is scattered by a centrifugal force is restricted thus maintaining a stable lubrication state.

Here, by forming the lubricating-oil-flow restricting portion 23 in a propeller shape, a windmill shape, fin shape arranged on a disc or the like, it is possible to further enhance an lubrication-oil agitating effect.

Further, by forming the helical grooves 24 in the distal end of the rotary shaft 11b of the flywheel 11 at a lower bearing portion 13 of the flywheel power supply device 20, it is possible to effectively introduce the lubrication oil A into a gap defined between a contact-bearing member 13b and the rotary shaft 11b due to the high-speed rotation of the rotary shaft 11b.

Such helical grooves may be formed in a distal end of the fixed shaft 22 of the upper bearing portion 21 in the same manner.

The flywheel power supply device 20 of the embodiment 2 is configured as described above and hence, it is possible to maintain the lubrication of the upper bearing portion 14 of the flywheel 11 in a favorable state. Further, due to the provision of the lubricating-oil-flow restricting portion 23 which is arranged in the lubricating oil storing portion 15, the lubricating oil stored in the inside of the lubricating oil storing portion 15 can be effectively agitated by restricting the lubricating oil around the fixed shaft 22. Accordingly, a quantity of lubricating oil between the fixed shaft 22 and the bearing hole 11c can be increased thus enhancing a lubrication effect and a cooling effect around the bearing. Due to such a constitution, the flywheel power supply device can be operated in a stable manner and hence, it is possible to surely operate the flywheel power supply device even in case of emergency such as an earthquake.

Here, the technical concept of the present invention is not limited to the technical concepts described in the embodiments 1 and 2. For example, in these embodiments, as the upper bearing structure of the flywheel, the pivot-shape structure in which the distal end of the fixed shaft 22 is formed in a spherical shape is adopted. However, it is also possible to form the lubricating oil storing portion on the flywheel side by applying a ball-bearing or the like as the upper bearing structure.

Further, a parts joining position, a size and a shape of the lubricating-oil-flow restricting portion may be suitably determined.

A hole size of the oil circulation passage formed in the fixed shaft of the upper bearing portion and the number of horizontal passages formed in the fixed shaft of the upper bearing portion are not limited to the above-mentioned hole size and number of the horizontal passages and are suitably determined depending on use modes such as a kind of the lubricating oil and a rotational speed of the flywheel.

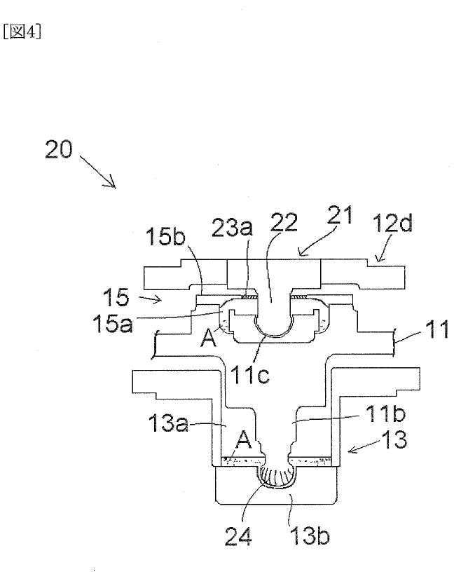

Further, as shown in FIG. 4, the lubricating oil A may be sealed in the inside of the oil pool portion 15a by interposing a doughnut-shaped seal ring 23a between the upper portion of the fixed shaft 22 and the lid portion 15b. That is, in this case, the seal ring 23a projects from the side wall surface of the fixed shaft 22 in a ring shape thus constituting a lubricating-oil-flow restricting portion.

### INDUSTRIAL APPLICABILITY

A flywheel power supply device of the present invention adopts the structure in which upper and lower portions of a rotary shaft of the flywheel are firmly held by a body casing and hence, the flywheel power supply device of the present invention can be industrially used as the backup power supply device in which the rotation of the flywheel is stabilized against vibrations or the like.

Further, in the flywheel power supply device of the present invention, the lubricating oil storing portion is arranged around the bearing hole of the flywheel and hence, the lubrication of the bearing hole formed in the upper portion of the flywheel which is rotated in a state that the rotary shaft of the flywheel is supported on the lower bearing portion is always held in a favorable state whereby troubles such as a energy loss attributed to a load resistance of the bearing portion and noises generated due to a precession of the flywheel can be effectively prevented.

Further, in the flywheel power supply device of the present invention, an oil circulation passage which takes in lubricating oil stored in the lubricating oil storing portion through the peripheral-wall intake ports and discharges the lubricating oil from the lower-end discharge port may be formed in the fixed shaft of the upper bearing portion. In this case, the oil circulation passage of the lubricating oil about the fixed shaft is formed and hence, the lubrication around the fixed shaft can be always held in a favorable state.

Further, in the flywheel power supply device of the present invention, the lubricating-oil-flow restricting portion formed in a projecting manner in a ring-shape or an umbrella-shape can be also mounted on the fixed shaft of the upper bearing portion. In this case, the flow of the lubricating oil around the fixed shaft which is held around the rotating bearing hole can be properly restricted and hence, it is possible to obtain an advantageous effect that maintainability of the flywheel power supply device is enhanced by properly holding such a lubrication state around the fixed shaft.

### BRIEF DESCRIPTION OF THE DRAWINGS

[FIG. 1] A cross-sectional view of a flywheel power supply device of an embodiment 1.

[FIG. 2] A partially enlarged view of the flywheel bearing structure of the flywheel power supply device of the embodiment 1.

[FIG. 3] A partially enlarged view of the bearing structure of a flywheel power supply device according to an embodiment 2.

[FIG. 4] A partially enlarged view of the bearing structure of a flywheel power supply device according to another embodiment.

### EXPLANATION OF SYMBOLS

10: flywheel power supply device of embodiment 1, 11: flywheel, 11a: permanent magnet, 11b: rotary shaft, 11c: bearing hole, 12: body casing, 12a: coil, 12b: core, 12c: lower casing, 12d: upper casing, 13: lower bearing portion, 13a: hollow portion, 13b: contact-bearing member, 14: upper bearing portion, 14a: fixed shaft, 14b: peripheral-wall intake port, 14c: lower-end discharge port, 15: lubricating oil storing portion, 15a: oil pool portion, 15b: lid portion, 20: flywheel power supply device of embodiment 2, 21: upper bearing portion, 22: fixed shaft, 23: lubricating-oil-flow restricting portion, 23a: seal ring, 24: helical groove, A: lubricating oil

1. A flywheel power supply device comprising:
a flywheel which is rotatably driven upon receiving supply of electricity, converts holding kinetic energy into electric energy when the supply of electricity is stopped, and discharges the electric energy;
a lower bearing portion which is fixed to a body casing for supporting a rotary shaft which is mounted on a lower side of the flywheel in a projecting manner;
an upper bearing portion which is fixed to the body casing, the upper bearing portion rotatably supporting an upper portion of the flywheel by fitting a fixed shaft which extends downwardly therefrom into a bearing hole formed in an upper surface of the flywheel; and
a lubricating oil storing portion which is formed around the bearing hole formed in the flywheel.

2. A flywheel power supply device according to claim 1, wherein an oil circulating passage which takes in lubricating oil stored in the lubricating oil storing portion through a peripheral-wall intake port formed in an upper-portion-side peripheral wall of the fixed shaft and discharges the lubricating oil from a lower-end discharge port of the fixed shaft is formed in the fixed shaft of the upper bearing portion.

3. A flywheel power supply device according to claim 1 or 2, wherein a lubricating-oil-flow restricting portion formed in a projecting manner in a ring-shape or an umbrella-shape is mounted on a side wall of the fixed shaft of the upper bearing portion
